(19) United States
(12) Patent Application Publication
(10) Pub. No.: US 2013/0042076 A1
(43) Pub. Date: Feb. 14, 2013

(54) CACHE MEMORY ACCESS METHOD AND CACHE MEMORY APPARATUS

(71) Applicants: Yen-Ju Lu, Hsinchu City (TW); Chao-Wei Huang, New Taipei City (TW)

(72) Inventors: Yen-Ju Lu, Hsinchu City (TW); Chao-Wei Huang, New Taipei City (TW)

(73) Assignee: REALTEK SEMICONDUCTOR CORP., Hsinchu (TW)

(21) Appl. No.: 13/569,831

(22) Filed: Aug. 8, 2012

(30) Foreign Application Priority Data
Aug. 9, 2011 (TW) 100128361
Jul. 18, 2012 (TW) 101125815

(51) Int. Cl. G06F 12/08

(52) U.S. Cl. 711/144; 711/E12.037

(57) ABSTRACT

A cache memory access method is to be implemented by a cache memory apparatus that includes a data storage unit which includes a plurality of storage sets each including a plurality of storage elements corresponding respectively to a plurality of access ways. The method includes: receiving from a processer a target address; determining whether the data storage unit stores target data corresponding to the target address; receiving the target data from a main memory if negative; selecting a chosen way from the plurality of access ways according to whether the storage elements of the storage set which corresponds to the target address store valid data and whether the target address corresponds to a predefined lock range in the main memory; and writing the target data in the data storage unit based on the chosen way.

### CROSS-REFERENCE TO RELATED APPLICATION

This application claims priority of Taiwanese Applications No. 100128361, filed on Aug. 9, 2011, and No. 101125815, filed on Jul. 18, 2012.

### BACKGROUND OF THE INVENTION

1. Field of the Invention

The present invention relates to a cache memory access method and cache memory apparatus, more particularly to a method and apparatus for locking and storing critical data in a cache memory.

2. Description of the Related Art

A cache memory is widely applied in a processing unit, such as a central processing unit (CPU). When the processing unit intends to access target data, access efficiency of the processing unit may be promoted if the target data has been stored in the cache memory.

Referring to FIG. 1, a processing unit 11 includes a processor 111 and a cache memory 112. The processor 111 is adapted to access target data in the cache memory 112. A cache hit occurs when the processor 111 is able to retrieve the target data in the cache memory 112. On the other hand, a cache miss occurs when the processor 111 is unable to retrieve the target data in the cache memory 112. The cache memory 112 is configured to retrieve the target data in a main memory 12 when a cache miss occurs.

U.S. Pat. No. 7,228,386 (the '386 patent hereinafter), a cache memory corresponds to a plurality of ways, and a way enable register is utilized to enable or disable each of the ways. For example, referring to FIG. 2, a cache memory 41 is assumed to include eight storage sets each corresponding respectively to indices S1˜S8. Each of the storage sets includes four storage elements that correspond respectively to four ways W1˜W4. The four ways W1˜W4 are a first way W1, a second way W2, a third way W3, and a fourth way W4. The way enable register 42 is four bits in size, and each of the four bits is configured to indicate whether a corresponding one of the four ways W1˜W4 is enabled or disabled. On the other words, it is assumed that the way enable register 42 has a value of 1110, and each of a zeroth bit to a third bit of the way enable register 42 is representative of the corresponding one of the first way W1 to the fourth way W4. The zeroth bit being 0 means that the first way W1 is disabled, so that the storage elements that correspond to the first way W1 may not be overwritten with other data.

In general, a purpose of this design resides in that when one of the storage elements that corresponds to the first way W1 stores critical data which is frequently used, writing of the first way W1 is disabled so as to avoid the need to retrieve the critical data from the main memory once again when the critical data is to be read next time due to overwriting of the storage element that stores the critical data, so that data access efficiency of the processing unit may not be decreased.

However, not all of the storage elements that correspond to the first way W1 have critical data stored therein. For example, referring to FIG. 2, the storage element that belongs to the storage set corresponding to the index S8 and that corresponds to the first way W1 (noted as (W1, S8) hereinafter, and the rest may be deduced by the same analogy), and the storage elements (W1, S7), (W1, S5), (W1, S4) and (W1, S3) all have respective critical data stored therein. Since the zeroth bit of the way enable register 42 is 0, other storage elements corresponding to the first way W1, such as (W1, S6), (W1, S2) and (W1, S1), are no longer able to store other data. In other words, utilization rate of the storage elements that correspond to the first way W1 is decreased to result in waste. Meanwhile, cache hit rate of the cache memory 41 is possibly decreased.

Even though an index register is introduced in the '386 patent to overcome this issue, complexity and cost of this design may be increased.

Furthermore, in U.S. Pat. No. 6,047,358 (the 358' patent hereinafter), a plurality of registers are utilized for setting size (LOCK_SIZE) and a low address (LOCK_ADDRESS) of a lock range, so as to define a space of the lock range in a cache memory for storing locked data.

However, after the space of the lock range is defined in the '358 patent, a plurality of initialization procedures are performed so as to lock most of critical data in the lock range. Moreover, when size of the critical data is larger than that of the cache memory, the '358 patent is incapable of defining the space of the lock range larger than size of the cache memory.

### SUMMARY OF THE INVENTION

Therefore, in a first aspect of the present invention, a cache memory access method is provided for overcoming at least one of the drawbacks of the prior art mentioned hereinabove.

Accordingly, the cache memory access method of the present invention is to be implemented by a cache memory apparatus that is coupled electrically to a processor and a main memory. The cache memory apparatus includes a data storage unit that includes a plurality of storage sets. Each of the storage sets includes a plurality of storage elements that correspond respectively to a plurality of access ways. The cache memory access method comprises:

configuring the cache memory apparatus to receive from the processer a target address;

configuring the cache memory apparatus to determine whether the data storage unit stores target data corresponding to the target address;

configuring the cache memory apparatus to receive the target data from the main memory after determining that the data storage unit does not store the target data corresponding to the target address;

configuring the cache memory apparatus to select a chosen way from the plurality of access ways according to whether the storage elements of the storage set which corresponds to the target address store valid data and whether the target address corresponds to a predefined lock range in the main memory; and

configuring the cache memory apparatus to write the target data in the data storage unit based on the chosen way.

In a second aspect of the present invention, a cache memory apparatus is provided for overcoming at least one of the drawbacks of the prior art mentioned hereinabove.

Accordingly, the cache memory apparatus of the present invention is to be coupled electrically to a main memory, and comprises:

a control unit defining a lock range in the main memory;

a data storage unit including a plurality of storage sets, each of which includes a plurality of storage elements; and

a critical bit unit for indicating whether data stored in each of the storage elements is within the lock range in the main memory;

wherein the lock range is larger than size of the data storage unit.

In a third aspect of the present invention, a cache memory access method is provided for overcoming at least one of the drawbacks of the prior art mentioned hereinabove.

Accordingly, the cache memory access method of the present invention is to be implemented by a cache memory apparatus that is coupled electrically to a processor and a main memory. The cache memory apparatus includes a data storage unit that includes a plurality of storage sets. Each of the storage sets includes a plurality of storage elements that correspond respectively to a plurality of access ways. The cache memory access method comprises:

configuring the cache memory apparatus to receive from the processer a target address and a critical notation, the critical notation being for indicating whether a target data corresponding to the target address in the main memory is critical data;

configuring the cache memory apparatus to determine whether the data storage unit stores the target data corresponding to the target address;

configuring the cache memory apparatus to receive the target data from the main memory after determining that the data storage unit does not store the target data corresponding to the target address;

configuring the cache memory apparatus to select a chosen way from the plurality of access ways according to whether the storage elements of the storage set which corresponds to the target address store valid data and whether the critical notation indicates that the target data corresponding to the target address in the main memory is critical data; and

configuring the cache memory apparatus to write the target data in the data storage unit based on the chosen way.

In a fourth aspect of the present invention, a cache memory apparatus capable of overcoming the aforementioned drawbacks of the prior art is provided for overcoming at least one of the drawbacks of the prior art mentioned hereinabove.

Accordingly, the cache memory apparatus of the present invention is to be coupled electrically to a processor and a main memory. The processor is adapted to determine a critical data storage range in the main memory. The cache memory apparatus comprises:

a control unit for receiving from the processer a target address and a critical notation, the critical notation being for indicating whether a target data corresponding to the target address in the main memory is critical data;

a data storage unit including a plurality of storage sets, each of which includes a plurality of storage elements; and

a critical bit unit for indicating whether data stored in each of the storage elements is critical data;

wherein the target data is indicated as critical data using the critical notation when the target address is within the critical data storage range in the main memory;

wherein size of the data storage unit of the cache memory apparatus is smaller than the critical data storage range in the main memory.

### BRIEF DESCRIPTION OF THE DRAWINGS

Other features and advantages of the present invention will become apparent in the following detailed description of the four preferred embodiments with reference to the accompanying drawings, of which:

FIG. 1 is a system block diagram of a prior art;

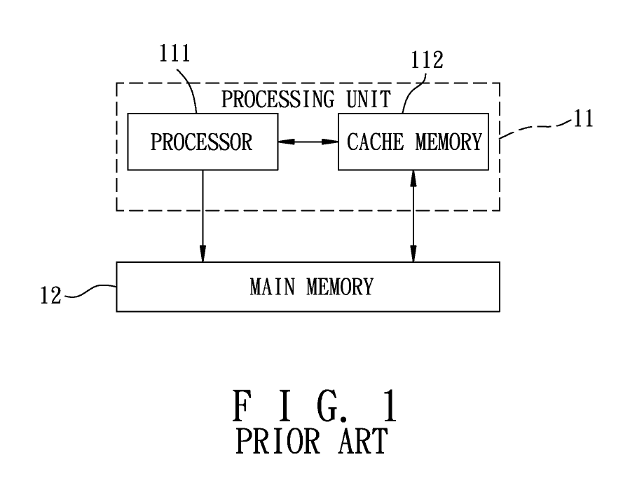

FIG. 2 is a schematic diagram illustrating control of ways of a cache memory in the prior art;

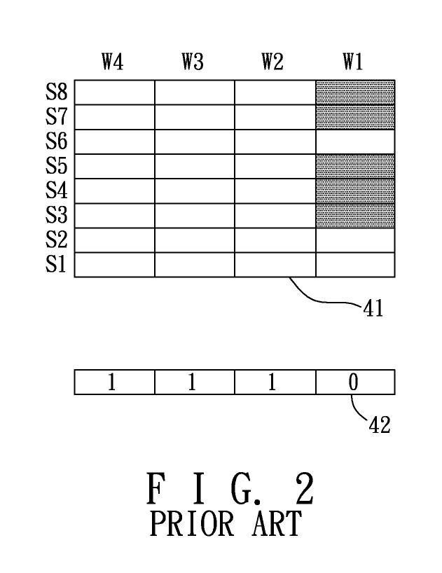

FIG. 3 is a system block diagram of a first preferred embodiment of a cache memory apparatus according to the present invention;

FIG. 4 is a schematic diagram illustrating storage spaces of the first preferred embodiment of the cache memory apparatus according to the present invention;

FIG. 5 is a flow chart illustrating a first preferred embodiment of a cache memory access method according to the present invention;

FIG. 6 is a flow chart illustrating a chosen way selection procedure of the first preferred embodiment of the cache memory access method according to the present invention;

FIG. 7 is a flow chart illustrating a first chosen way selection sub-procedure of the first preferred embodiment of the cache memory access method according to the present invention;

FIG. 8 is a flow chart illustrating a second chosen way selection sub-procedure of the first preferred embodiment of the cache memory access method according to the present invention;

FIG. 9 is a flow chart illustrating a third chosen way selection sub-procedure of the first preferred embodiment of the cache memory access method according to the present invention;

FIGS. 10(a) to 10(d) and FIGS. 11(a) to 11(d) are schematic diagrams illustrating an example implemented using the first preferred embodiment of the cache memory access method according to the present invention;

FIG. 12 is a flow chart illustrating another preferred embodiment of a cache memory access method according to the present invention;

FIG. 13 is a system block diagram of a second preferred embodiment of a cache memory apparatus according to the present invention;

FIG. 14 is a flow chart illustrating a second preferred embodiment of a cache memory access method according to the present invention;

FIG. 15 is a flow chart illustrating a chosen way selection procedure of the second preferred embodiment of the cache memory access method according to the present invention;

FIG. 16 is a flow chart illustrating a third chosen way selection sub-procedure of the second preferred embodiment of the cache memory access method according to the present invention; and

FIG. 17 is a flow chart illustrating yet another preferred embodiment of a cache memory access method according to the present invention.

### DETAILED DESCRIPTION OF THE PREFERRED EMBODIMENTS

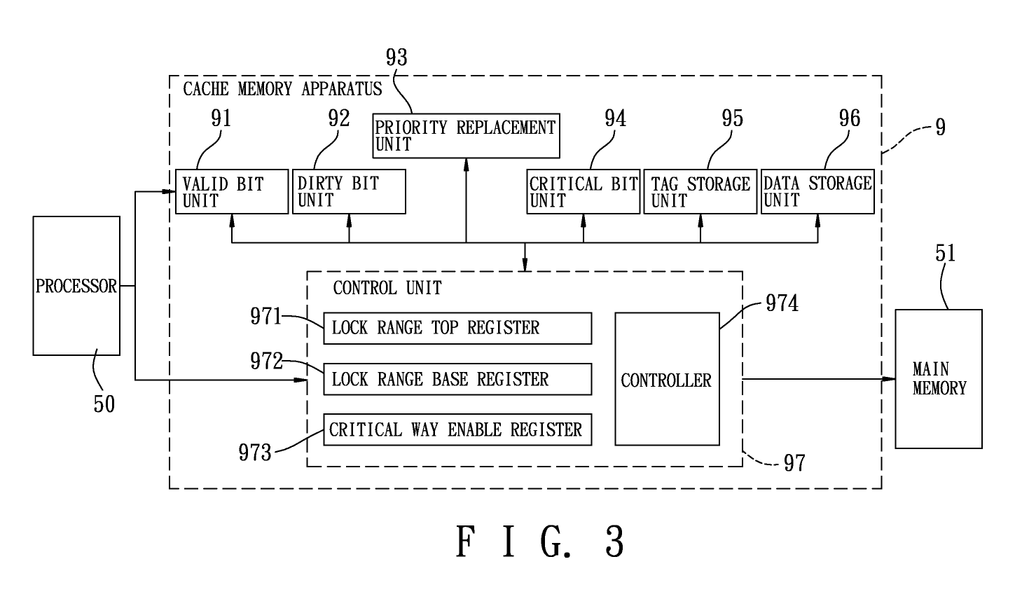

Referring to FIG. 3, a first preferred embodiment of a cache memory apparatus 9, according to the present invention, is to be coupled electrically to a processor 50 and a main memory 51, and is configured to receive from the processor 50 a target address. The target address includes a Tag field and an Index field. The first preferred embodiment of the cache memory apparatus 9 comprises a valid bit unit 91, a dirty bit unit 92, a priority replacement unit 93, a critical bit unit 94, a tag storage unit 95, a data storage unit 96, and a control unit 97.

The control unit 97 includes a lock range top register 971, a lock range base register 972, a critical way enable register 973, and a controller 974.

The lock range top register 971 and the lock range base register 972 are configured to define a lock range in the main memory 51. Compared with the aforementioned prior art, the lock range is defined in the main memory 51 and not in the cache memory apparatus 9, such that the lock range may be set to be smaller than, equal to, or even larger than size of the cache memory apparatus 9. The critical way enable register 973 is configured to indicate whether each of a plurality of access ways is locked.

In this embodiment, the data storage unit 96 is a data memory, and is configured to store data to be stored in the cache memory apparatus 9. The data storage unit 96 includes a plurality of storage sets, and each of the storage sets includes a plurality of storage elements that correspond respectively to the plurality of access ways. The valid bit unit 91 is a valid bit memory, and each bit of the valid bit unit 91 indicates whether a corresponding one of the storage elements stores valid data. In general, the bit being 1 in value means that the corresponding one of the storage elements stores valid data, and the bit being 0 in value means that the corresponding one of the storage elements stores invalid data. The dirty bit unit 92 is a dirty bit memory, and each bit of the dirty bit unit 92 indicates whether a corresponding one of the storage elements stores dirty data, i.e., must be written back to the main memory 51. In general, the bit being 1 in value means that a corresponding one of the storage elements stores dirty data, and the bit being 0 in value means that the corresponding one of the storage elements stores clean data, i.e., unnecessary to be written back to the main memory 51. The priority replacement unit 93 is a least recently used (LRU) memory, and is adapted to indicate a replacement order of data stored in each of the storage elements. Ordering of data stored in each of the storage elements is performed based on a LRU algorithm, i.e., data indicated as first priority is the first one to be replaced when there is new data to be stored in the cache memory apparatus 9. The critical bit unit 94 is a critical bit memory, and each bit of the critical bit unit 94 indicates whether a corresponding one of the storage elements stores critical data. In general, the bit being 1 in value means that the corresponding one of the storage elements stores critical data, i.e., the critical data is within the lock range in the main memory 51, and the bit being 0 in value means that the corresponding one of the storage elements stores non-critical data. The tag storage unit 95 is a tag memory that indicates an address of data, which is stored in each of the storage elements, in the main memory 51.

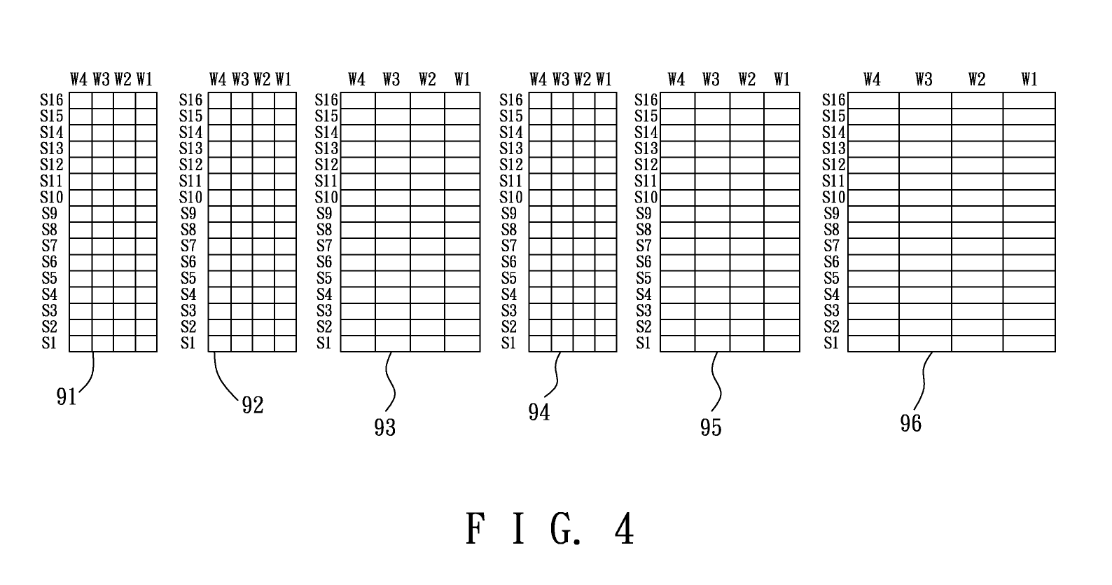

Referring to FIG. 4, in this preferred embodiment, the data storage unit 96 is assumed to include sixteen storage sets corresponding respectively to indices S1˜S16. Each of the sixteen storage sets includes four storage elements that correspond respectively to four access ways W1˜W4. Therefore, the data storage unit 96 includes the 4×16 storage elements. Similarly, each of the valid bit unit 91, the dirty bit unit 92, the priority replacement unit 93, the critical bit unit 94 and the tag storage unit 95 includes 4×16 storage spaces that correspond respectively to the 4×16 storage elements. Therefore, the 4×16 storage spaces may also be addressed by means of the indices S1˜S16 and the access ways W1˜W4.

The aforementioned cache memory apparatus 9 is configured to implement a cache memory access method of the present invention. The cache memory access method is described in detail hereinafter.

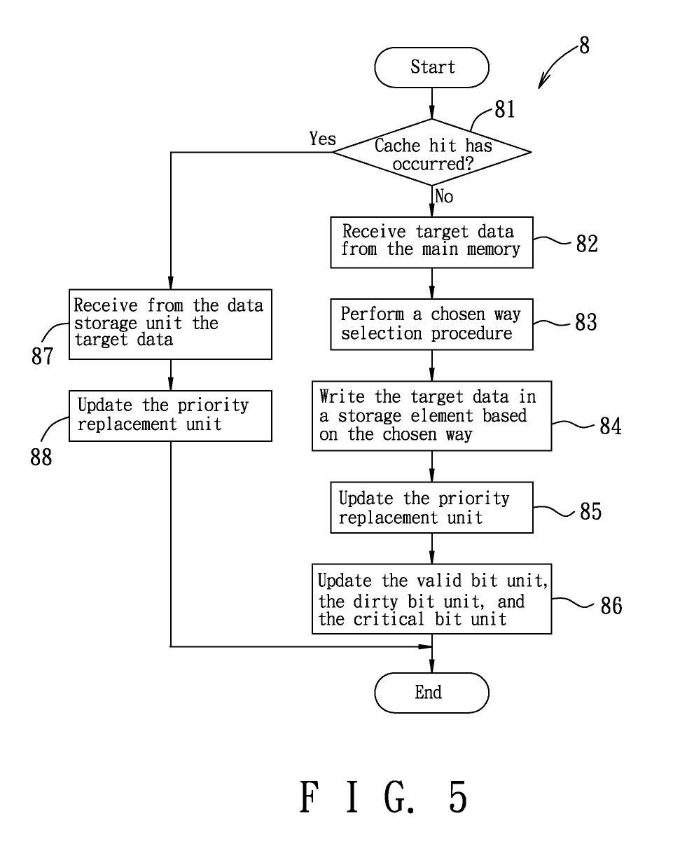

Referring to FIG. 3 and FIG. 5, a first preferred embodiment of the cache memory access method 8, according to the present invention, is to be implemented by the aforementioned cache memory apparatus 9 and comprises the following steps.

In step 81, the controller 974 is configured to determine whether any of the storage elements of the data storage unit 96 stores target data according to the target address and the tag storage unit 95, that is, to determine whether a cache hit has occurred. In this embodiment, the controller 974 is configured to determine whether an address which corresponds to the tag field of the target address is indicated in the storage spaces, which correspond to the index field of the target address, of the tag storage unit 95. When the controller 974 determines that the address is indicated in the storage spaces, it means that the storage elements corresponding to the index field of the target address store the target data.

In step 82, the controller 974 is configured to receive the target data from the main memory 51 after determining that none of the storage elements of the data storage unit 96 stores the target data. In this embodiment, the controller 974 is configured to receive the target data from the main memory 51 according to the tag field of the target address.

In step 83, the controller 974 is configured to perform a chosen way selection procedure, so as to select a chosen way from the plurality of access ways.

In step 84, the controller 974 is configured to write the target data received in step 82 in a storage element that belongs to the storage set corresponding to the index field of the target address and that corresponds to the chosen way.

In step 85, the controller 974 is configured to update the priority replacement unit 93 so as to shift backward the replacement order of the target data in the storage element that belongs to the storage set corresponding to the index field of the target address and that corresponds to the chosen way. It is noted that, in this embodiment, the priority replacement unit 93 is updated based on the LRU algorithm, and since the LRU algorithm is well known to those skilled in art, further details of the same are omitted herein for the sake of brevity. Moreover, the priority replacement unit 93 is not limited to the manner of updating the replacement order disclosed in the present invention.

In step 86, the controller 974 is configured to update the valid bit unit 91 and the dirty bit unit 92, and to update the critical bit unit 94 when the address which corresponds to the tag field of the target address is within the lock range. The flow ends. In this embodiment, the valid bit unit 91, the dirty bit unit 92, and the critical bit unit 94 are updated such that each indicates storage of valid data, dirty data, and critical data, respectively.

In step 87, the controller 974 is configured to receive from the data storage unit 96 the target data corresponding to the target address after determining that one of the storage elements of the data storage unit 96 stores the target data in step 81.

In step 88, the controller 974 is configured to update the priority replacement unit 93 so as to shift backward the replacement order of the target data in the storage element that belongs to the storage set corresponding to the index field of the target address. The flow ends.

It is noted that, in this embodiment, step 82 is performed prior to step 83. However, in other embodiments, step 83 may be performed prior to step 82, and alternatively, step 82 and step 83 maybe performed simultaneously.

It is noted that, how to effectively select the chosen way for storing the target data so as to promote cache hit rate of the cache memory apparatus 9 is an important consideration in the cache memory access method 8. Therefore, the chosen way selection procedure for selecting the chosen way disclosed in step 83 is critical and will be described in detail hereinafter.

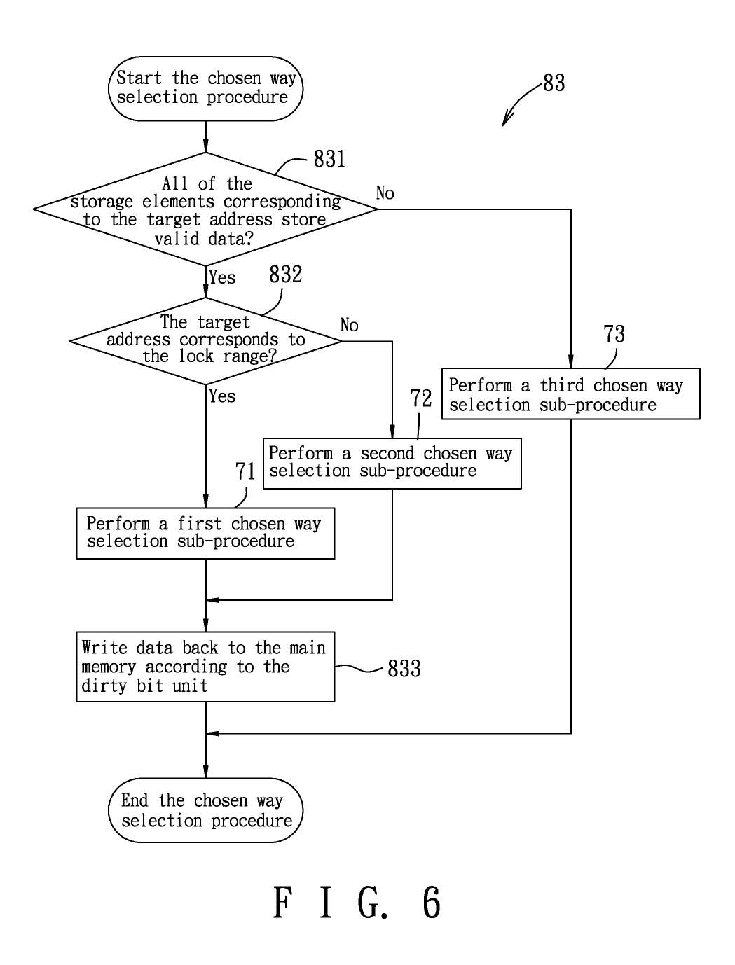

Referring to FIG. 3 and FIG. 6, the chosen way selection procedure includes the following sub-steps.

In sub-step 831, the controller 974 is configured to determine, from the valid bit unit 91, whether all of the storage elements of the storage set which corresponds to the index field of the target address store valid data.

In sub-step 832, the controller 974 is configured to determine whether the address corresponding to the tag field of the target address is within the lock range in the main memory 51 after determining that all of the storage elements of the storage set which corresponds to the index field of the target address store valid data.

In sub-step 71, the controller 974 is configured to perform a first chosen way selection sub-procedure so as to select the chosen way after determining that the address corresponding to the tag field of the target address is within the lock range in the main memory 51, and the flow goes to sub-step 833.

In sub-step 72, the controller 974 is configured to perform a second chosen way selection sub-procedure so as to select the chosen way after determining that the address corresponding to the tag field of the target address is not within the lock range in the main memory 51 in sub-step 832, and the flow goes to sub-step 833.

In sub-step 73, the controller 974 is configured to perform a third chosen way selection sub-procedure so as to select the chosen way after determining that not all of the storage elements of the storage set which corresponds to the index field of the target address store valid data in sub-step 831.

In sub-step 833, the controller 974 is configured to write data, which is stored in the storage element that belongs to the storage set corresponding to the index field of the target address and that corresponds to the chosen way, back to the main memory 51 according to the dirty bit unit 92 when the storage element is indicated as storing dirty data. The flow of the chosen way selection procedure ends after sub-step 73 or sub-step 833.

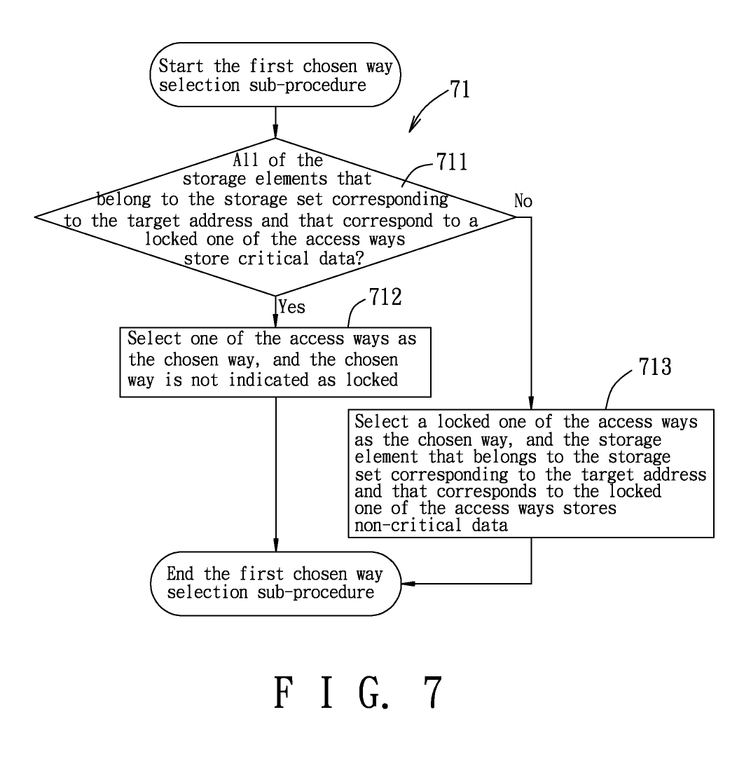

Referring to FIG. 3 and FIG. 7, the first chosen way selection sub-procedure includes the following sub-steps.

In sub-step 711, the controller 974 is configured to make a first determination according to the critical bit unit 94 and the critical way enable register 973 as to whether all of the storage elements that belong to the storage set corresponding to the index field of the target address and that correspond to a locked one of the access ways store critical data.

In sub-step 712, the controller 974 is configured to select one of the access ways as the chosen way, and the chosen way is not indicated as locked when a result of the first determination made in sub-step 711 is affirmative. The flow of the first chosen way selection sub-procedure ends after sub-step 712. In this embodiment, the controller 974 is configured to select based on the priority replacement unit 93 when there are multiple ones of the access ways available for selection as the chosen way.

In sub-step 713, the controller 974 is configured to select a locked one of the access ways as the chosen way, and the storage element that belongs to the storage set corresponding to the index field of the target address and that corresponds to the locked one of the access ways stores non-critical data when the result of the first determination made in sub-step 711 is negative. The flow of the first chosen way selection sub-procedure ends after sub-step 713.

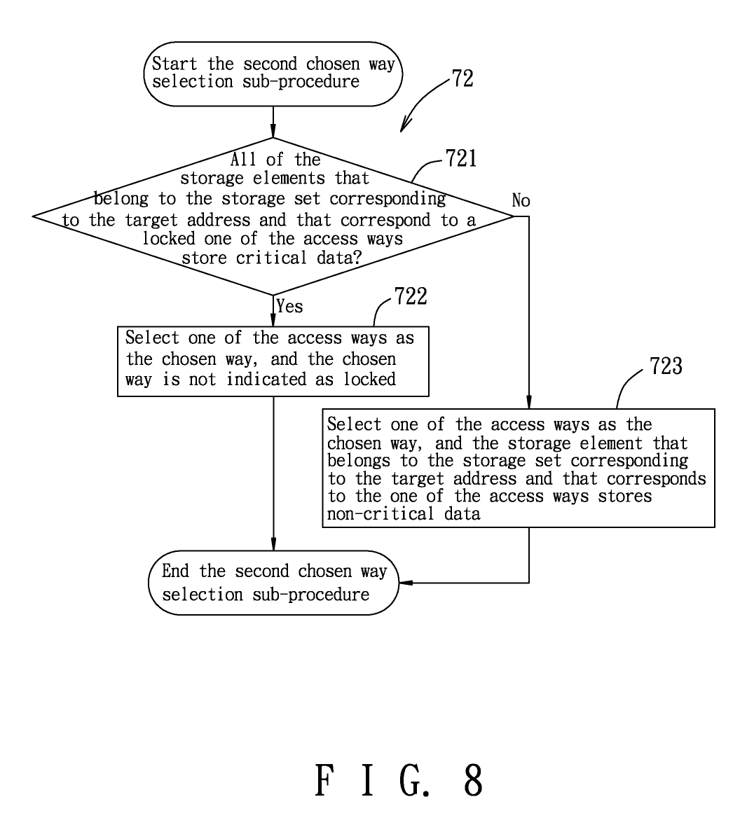

Referring to FIG. 3 and FIG. 8, the second chosen way selection sub-procedure includes the following sub-steps.

In sub-step 721, the controller 974 is configured to make a second determination according to the critical bit unit 94 and the critical way enable register 973 as to whether all of the storage elements that belong to the storage set corresponding to the index field of the target address and that correspond to a locked one of the access ways store critical data.

In sub-step 722, the controller 974 is configured to select one of the access ways as the chosen way, and the chosen way is not indicated as locked when a result of the second determination made in sub-step 721 is affirmative. The flow of the first chosen way selection sub-procedure ends after sub-step 722.

In sub-step 723, the controller 974 is configured to select one of the access ways as the chosen way, and the storage element that belongs to the storage set corresponding to the index field of the target address and that corresponds to the one of the access ways stores non-critical data when the result of the second determination made in sub-step 711 is negative. The flow of the second chosen way selection sub-procedure ends after sub-step 723.

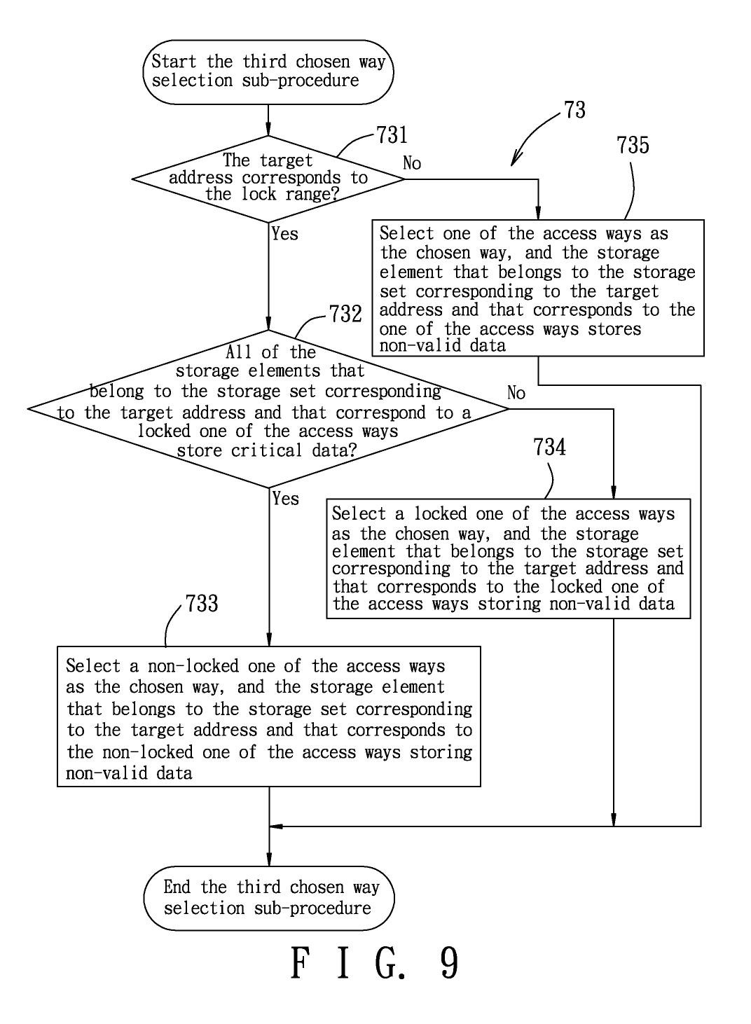

Referring to FIG. 3 and FIG. 9, the third chosen way selection sub-procedure includes the following sub-steps.

In sub-step 731, the controller 974 is configured to determine whether the address corresponding to the tag field of the target address is within the lock range in the main memory 51.

In sub-step 732, the controller 974 is configured to make a third determination according to the critical bit unit 94 and the critical way enable register 973 as to whether all of the storage elements that belong to the storage set corresponding to the index field of the target address and that correspond to a locked one of the access ways store critical data after determining that the address corresponding to the tag field of the target address is within the lock range in the main memory 51.

In step 733, the controller 974 is configured to select a non-locked one of the access ways as the chosen way, and the storage element that belongs to the storage set corresponding to the index field of the target address and that corresponds to the non-locked one of the access ways stores non-valid data when a result of the third determination made in sub-step 732 is affirmative. The flow of the third chosen way selection sub-procedure ends after sub-step 733.

In sub-step 734, the controller 974 is configured to select a locked one of the access ways as the chosen way, and the storage element that belongs to the storage set corresponding to the index field of the target address and that corresponds to the locked one of the access ways stores non-valid data when the result of the third determination made in sub-step 732 is negative. The flow of the third chosen way selection sub-procedure ends after sub-step 734.

In sub-step 735, the controller 974 is configured to select one of the access ways as the chosen way, and the storage element that belongs to the storage set corresponding to the index field of the target address and that corresponds to the one of the access ways stores non-valid data after determining that the address corresponding to the tag field of the target address is not within the lock range in the main memory 51 in sub-step 731. The flow of the third chosen way selection sub-procedure ends after sub-step 735.

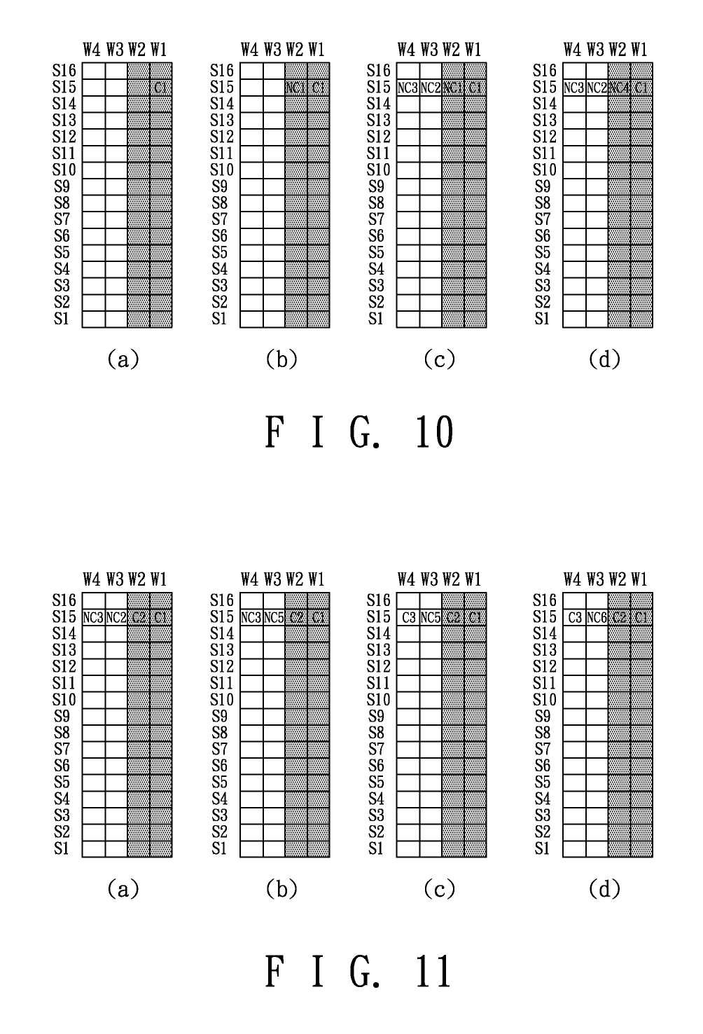

For example, referring to FIG. 3 and FIGS. 10(a) to 10(d), it is assumed that the controller 974 is configured to select, according to the index field of the target address, a corresponding one of the storage sets of the data storage unit 96 (for example, the storage set corresponding to the index S15), and that the critical way enable register 973 has a corresponding value of 0011 which means the access ways W1, W2 are indicated as locked and the access ways W3, W4 are indicated as non-locked. It is further assumed that the valid bit unit 91 has a corresponding value of 0000 and the critical bit unit 94 has a corresponding value of 0000 which means the storage elements (W1, S15), (W2, S15), (W3, S15) and (W4, S15) are indicated as storing non-valid and non-critical data.

A set of target data is assumed to be written in the cache memory apparatus 9 in the following order: C1, NC1, NC2, NC3, NC4, C2, NC5, C3 and NC6, wherein C represents that the target data is critical data, and NC represents that the target data is non-critical data.

When the controller 974 is about to write the target data C1, according to sub-step 831 (see FIG. 6), since not all of the storage elements (W1, S15), (W2, S15), (W3, S15) and (W4, S15) are indicated as storing valid data, the flow goes to sub-step 73. According to sub-step 731 (see FIG. 9), since the target data C1 is critical data (i.e., the address corresponding to the tag field of the target address, to which the target data C1 corresponds, is within the lock range), the flow goes to sub-step 732. According to sub-step 732, since not all of the storage elements (W1, S15) and (W2, S15) are indicated as storing critical data (data in these storage elements do not correspond to the lock range), the flow goes to sub-step 734. According to sub-step 734, since the access ways W1 and W2 are indicated as locked, and the storage elements (W1, S15) and (W2, S15) are not indicated as storing valid data, any one of the access ways W1 and W2 may be selected as the chosen way. The access way W1 is assumed to be selected as the chosen way. Subsequently, according to step 84 (see FIG. 5), the target data C1 is written in the storage element (W1, S15) as illustrated in FIG. 10(a). According to step 86, the storage element (W1, S15) is indicated as storing valid and critical data.

When the controller 974 is about to write the target data NC1, according to sub-step 831 (see FIG. 6), since not all of the storage elements (W1, S15), (W2, S15), (W3, S15) and (W4, S15) are indicated as storing valid data, the flow goes to sub-step 73. According to sub-step 731 (see FIG. 9), since the target data NC1 is non-critical data, the flow goes to sub-step 735. According to sub-step 735, since the storage elements (W2, S15), (W3, S15) and (W4, S15) are indicated as storing non-valid data, any one of the access ways W2, W3 and W4 may be selected as the chosen way. The access way W2 is assumed to be selected as the chosen way. Subsequently, according to step 84 (see FIG. 5), the target data NC1 is written in the storage element (W2, S15) as illustrated in FIG. 10(b). According to step 86, the storage element (W2, S15) is indicated as storing valid data.

Similar to a process of writing the target data NC1, the target data NC2 is written in the storage element (W3, S15) as illustrated in FIG. 10(c), and the storage element (W3, S15) is indicated as storing valid data. The target data NC3 is written in the storage element (W4, S15) as illustrated in FIG. 10(c), and the storage element (W4, S15) is indicated as storing valid data.

At this time, all of the storage elements (W1, S15), (W2, S15), (W3, S15) and (W4, S15) are indicated as storing valid data.

When the controller 974 is about to write the target data NC4, according to sub-step 831 (see FIG. 6), since all of the storage elements (W1, S15), (W2, S15), (W3, S15) and (W4, S15) are indicated as storing valid data, the flow goes to sub-step 832. According to sub-step 832, since the target data NC4 is non-critical data, the flow goes to sub-step 72. According to sub-step 721 (see FIG. 8), since not all of the storage elements (W1, S15) and (W2, S15) are indicated as storing critical data, the flow goes to sub-step 723. According to sub-step 723, since the storage elements (W2, S15), (W3, S15) and (W4, S15) are indicated as storing non-critical data, any one of the access ways W2, W3 and W4 may be selected as the chosen way. The access way W2 is assumed to be selected as the chosen way. Subsequently, according to step 84 (see FIG. 5), the target data NC4 is written in the storage element (W2, S15) as illustrated in FIG. 10(d). According to step 86, the storage element (W2, S15) is indicated as storing valid data.

Referring to FIG. 3 and FIGS. 11(a) to 11(d), when the controller 974 is about to write the target data C2, according to sub-step 831 (see FIG. 6), since all of the storage elements (W1, S15), (W2, S15), (W3, S15) and (W4, S15) are indicated as storing valid data, the flow goes to sub-step 832. According to sub-step 832, since the target data C2 is critical data, the flow goes to sub-step 71. According to sub-step 711(see FIG. 7), since not all of the storage elements (W1, S15) and (W2, S15) are indicated as storing critical data, the flow goes to sub-step 713. According to sub-step 713, since the access ways W1 and W2 are indicated as locked, and the storage element (W2, S15) is indicated as storing non-critical data, the access way W2 may be selected as the chosen way. Subsequently, according to step 84 (see FIG. 5), the target data C2 is written in the storage element (W2, S15) as illustrated in FIG. 11(a). According to step 86, the storage element (W2, S15) is indicated as storing valid and critical data.

At this time, all of the storage elements (W1, S15) and (W2, S15) are indicated as storing critical data.

When the controller 974 is about to write the target data NC5, according to sub-step 831 (see FIG. 6), since all of the storage elements (W1, S15), (W2, S15), (W3, S15) and (W4, S15) are indicated as storing valid data, the flow goes to sub-step 832. According to sub-step 832, since the target data NC5 is non-critical data, the flow goes to sub-step 72. According to sub-step 721 (see FIG. 8), since the storage elements (W1, S15) and (W2, S15) are indicated as storing critical data, the flow goes to sub-step 722. According to sub-step 722, since the access ways W3 and W4 are indicated as non-locked, any one of the access ways W3 and W4 may be selected as the chosen way. The access way W3 is assumed to be selected as the chosen way. Subsequently, according to step 84 (see FIG. 5), the target data NC5 is written in the storage element (W3, S15) as illustrated in FIG. 11(b). According to step 86, the storage element (W3, S15) is indicated as storing valid data.

When the controller 974 is about to write the target data C3, according to sub-step 831 (see FIG. 6), since all of the storage elements (W1, S15), (W2, S15), (W3, S15) and (W4, S15) are indicated as storing valid data, the flow goes to sub-step 832. According to sub-step 832, since the target data C3 is critical data, the flow goes to sub-step 71. According to sub-step 711(see FIG. 7), since the storage elements (W1, S15) and (W2, S15) are indicated as storing critical data, the flow goes to sub-step 712. According to sub-step 712, since the access ways W3 and W4 are indicated as non-locked, any one of the access ways W3 and W4 may be selected as the chosen way. The access way W4 is assumed to be selected as the chosen way based on the priority replacement unit 93. Subsequently, according to step 84 (see FIG. 5), the target data C3 is written in the storage element (W4, S15) as illustrated in FIG. 11(c). According to step 86, the storage element (W4, S15) is indicated as storing valid and critical data.

When the controller 974 is about to write the target data NC6, according to sub-step 831 (see FIG. 6), since all of the storage elements (W1, S15), (W2, S15), (W3, S15) and (W4, S15) are indicated as storing valid data, the flow goes to sub-step 832. According to sub-step 832, since the target data NC6 is non-critical data, the flow goes to sub-step 72. According to sub-step 721 (see FIG. 8), since the storage elements (W1, S15) and (W2, S15) are indicated as storing critical data, the flow goes to sub-step 722. According to sub-step 722, since the access ways W3 and W4 are indicated as non-locked, any one of the access ways W3 and W4 may be selected as the chosen way. The access way W3 is assumed to be selected as the chosen way. Subsequently, according to step 84 (see FIG. 5), the target data NC6 is written in the storage element (W3, S15) as illustrated in FIG. 11(c). According to step 86, the storage element (W3, S15) is indicated as storing valid data.

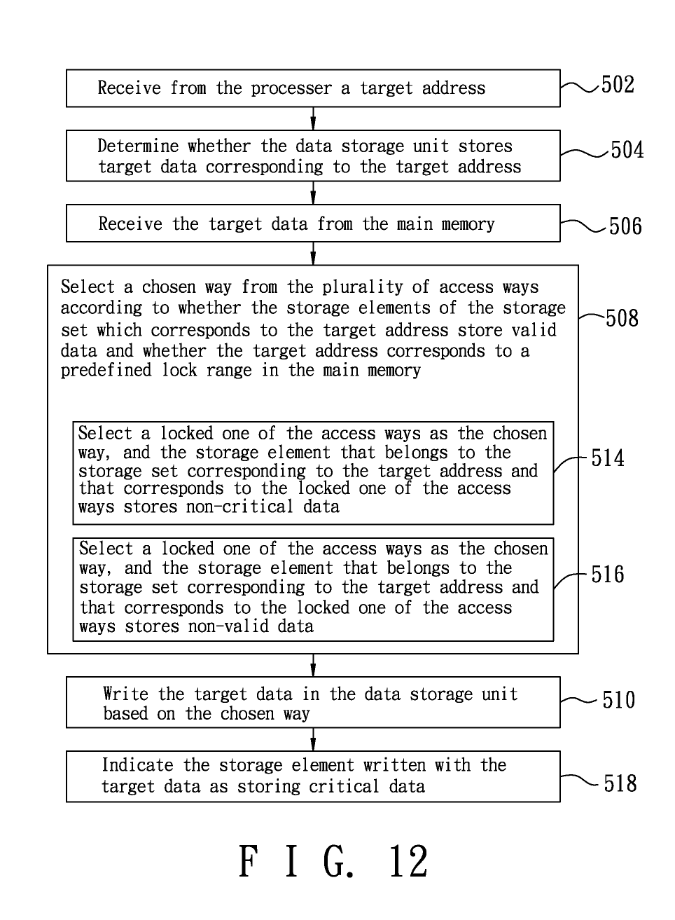

Referring to FIG. 3 and FIG. 12, another preferred embodiment of the cache memory access method, according to the present invention, is to be implemented by a cache memory apparatus 9 that is coupled electrically to a processor 50 and a main memory 51. The cache memory apparatus 9 includes a control unit 97 and a data storage unit 96. The data storage unit 96 includes a plurality of storage sets, and each of the storage sets includes a plurality of storage elements that correspond respectively to a plurality of access ways. The cache memory access method of this embodiment comprises the following steps.

In step 502, the control unit 97 is configured to receive from the processer 50 a target address.

In step 504, the control unit 97 is configured to determine whether the data storage unit 96 stores target data corresponding to the target address.

In step 506, the control unit 97 is configured to receive the target data from the main memory 51 after determining that the data storage unit 96 does not store the target data corresponding to the target address.

In step 508, the control unit 97 is configured to select a chosen way from the plurality of access ways according to whether the storage elements of the storage set which corresponds to the target address store valid data and whether the target address corresponds to a predefined lock range in the main memory 51.

In step 510, the control unit 97 is configured to write the target data in the data storage unit 96 based on the chosen way.

Preferably, the lock range in the main memory 51 is larger than size of the data storage unit 96 of the cache memory apparatus 9.

Preferably, in step 508, the control unit 97 is configured to select the chosen way according to whether all of the storage elements that belong to the storage set corresponding to the target address and that correspond to a locked one of the access ways store critical data.

Preferably, step 508 includes the following sub-step.

In sub-step 514, the control unit 97 is configured to select a locked one of the access ways as the chosen way, and the storage element that belongs to the storage set corresponding to the target address and that corresponds to the locked one of the access ways stores non-critical data.

Preferably, step 508 includes the following sub-step.

In sub-step 516, the control unit 97 is configured to select a locked one of the access ways as the chosen way, and the storage element that belongs to the storage set corresponding to the target address and that corresponds to the locked one of the access ways stores non-valid data.

Preferably, the cache memory access method further comprises the following step.

In step 518, the control unit 97 is configured to indicate the storage element written with the target data as storing critical data when the target address corresponding to the storage set to which the storage element belongs is within the lock range.

In summary, the aforementioned embodiments, by utilizing the critical bit unit 94 in combination with the critical way enable register 973, are still capable of accessing a storage element which corresponds to a locked one of the access ways and which stores non-critical or non-valid data by means of indication of the critical bit unit 94 even when the critical way enable register 973 locks a portion of the access ways. Therefore, the issue, which concerns the rest of the storage elements corresponding to one of the ways that is locked for reserving critical data being no longer usable, encountered in the '386 patent may be overcome. Meanwhile, the aforementioned embodiments may promote the cache hit rate. Moreover, since the storage elements that correspond to the non-locked one of the access ways and that store critical data may be overwritten, the lock range may be larger than size of the cache memory apparatus 9, such that an issue encountered in the '358 patent may be overcome. That is, when the lock range is larger than the size of the cache memory apparatus, related register being required to be reset and inconvenience being caused may be avoided. Meanwhile, since the aforementioned embodiments do not need any initialization procedures, utilization efficiency may be promoted.

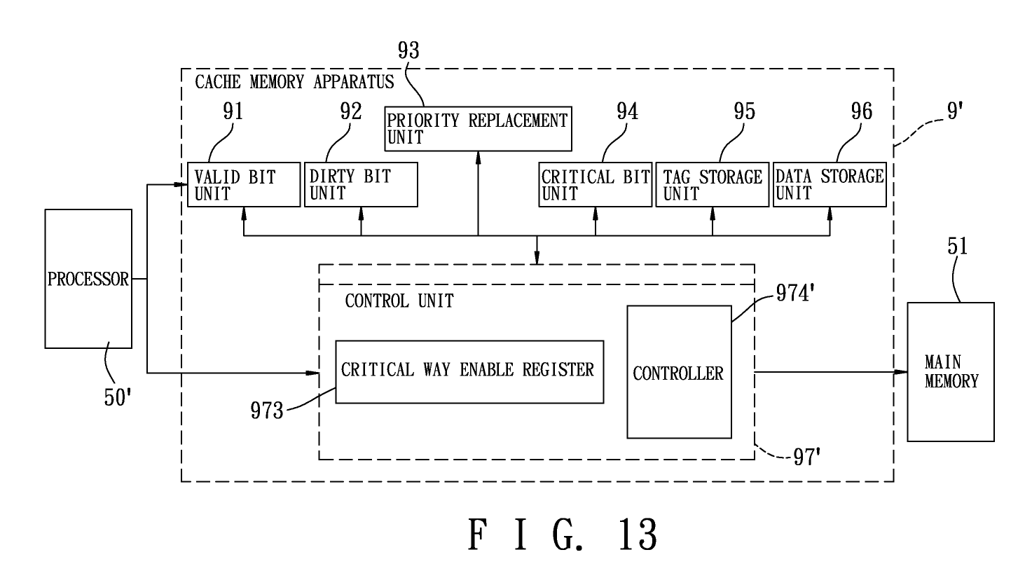

Referring to FIG. 13, according to the present invention, a second preferred embodiment of the cache memory apparatus 9′ similar to the first preferred embodiment illustrated in FIG. 3 is shown. The second preferred embodiment differs from the previous embodiment in the following. First of all, the control unit 97′ of the second preferred embodiment of the cache memory apparatus 9′ does not include the lock range top register 971 and the lock range base register 972 (see FIG. 3). Second, the control unit 97′ is further configured to receive a critical notation from the processor 50′. The critical notation is for indicating whether the target data corresponding to the target address in the main memory 51 is critical data. In this embodiment, the processor 50′ may determine a critical data storage range in the main memory 51, and the target data is indicated as critical data using the critical notation when the address which corresponds to the tag field of the target address (i.e., the address of the target data) is within the critical data storage range in the main memory 51. Thirdly, the controller 974′ of the control unit 97′ performs different operations.

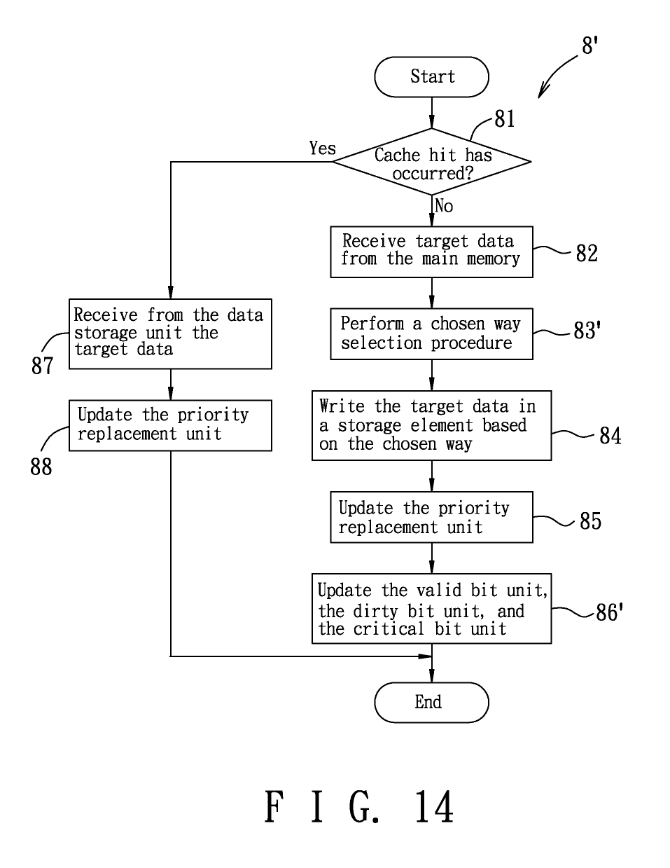

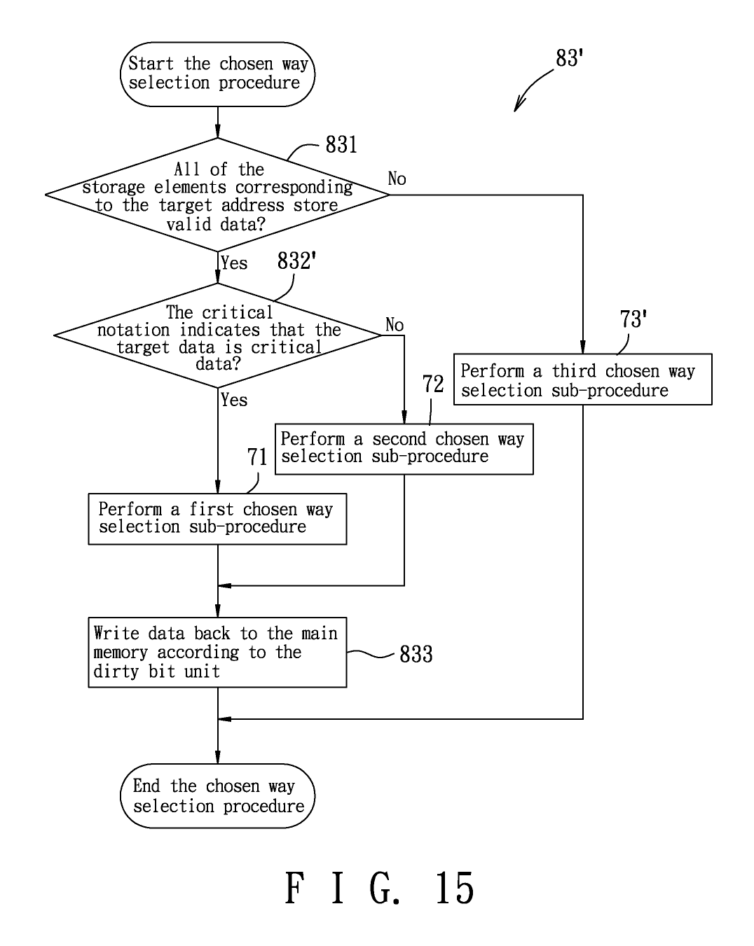

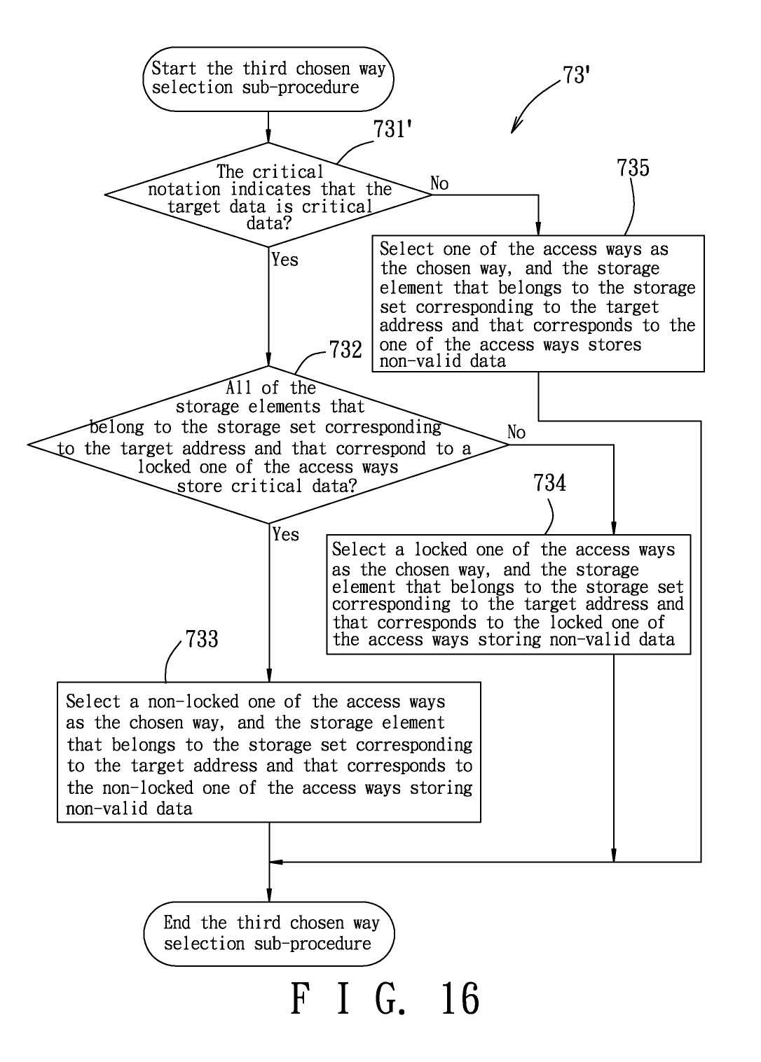

Referring to FIGS. 13 to 16, a second preferred embodiment of the cache memory access method, according to the present invention, is to be implemented by the aforementioned cache memory apparatus 9′, and is similar to the first preferred embodiment of the cache memory access method shown in FIGS. 5 to 9. Differences of the second preferred embodiment of the cache memory access method from the first preferred embodiment are listed in the following. First of all, in step 86′, the controller 974′ is configured to update the valid bit unit 91 and the dirty bit unit 92, and to update the critical bit unit 94 when the critical notation indicates that the target data corresponding to the target address in the main memory 51 is critical data. Second, in sub-step 832′, the controller 974′ is configured to determine whether the critical notation indicates that the target data corresponding to the target address in the main memory 51 is critical data. When it is determined in sub-step 832′ that the target data corresponding to the target address in the main memory 51 is critical data, the flow proceeds to sub-step 71. Otherwise, the flow proceeds to sub-step 72. Third, in sub-step 731′, the controller 974′ is configured to determine whether the critical notation indicates that the target data corresponding to the target address in the main memory 51 is critical data. When it is determined in sub-step 731′ that the target data corresponding to the target address in the main memory 51 is critical data, the flow proceeds to sub-step 732. Otherwise, the flow proceeds to sub-step 735.

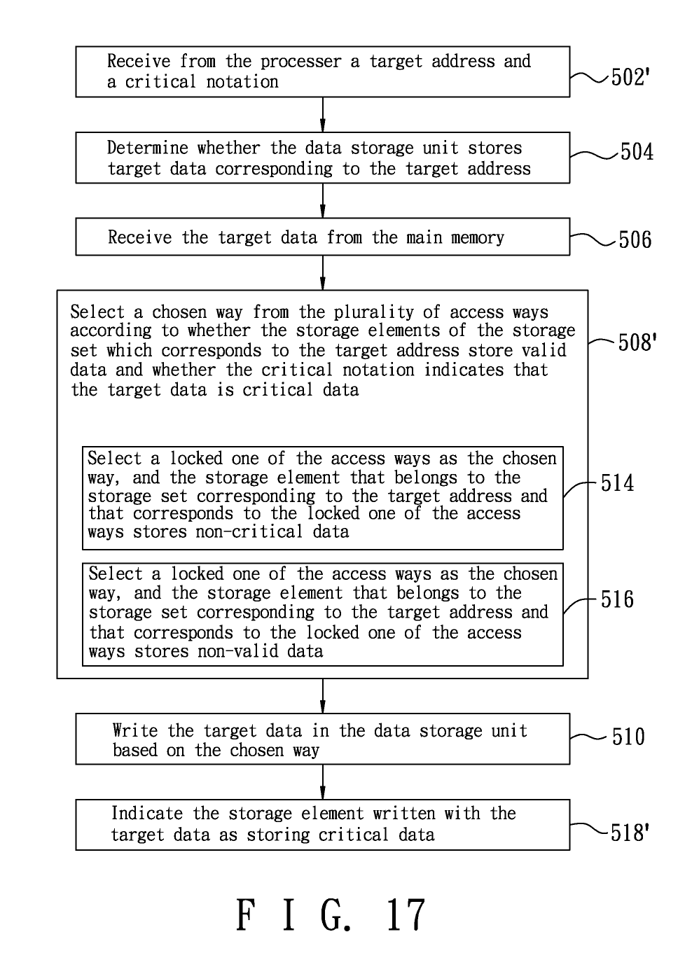

Referring FIG. 13 and FIG. 17, yet another preferred embodiment of the cache memory access method, according to the present invention, is shown to be similar to the previously described preferred embodiments. This embodiment has the following differences with the previous embodiments.

In step 502′, the control unit 97′ is configured to receive from the processor 50′ a target address and a critical notation. The critical notation is for indicating whether a target data corresponding to the target address in the main memory 51 is critical data. In this embodiment, the processor 50′ may determine a critical data storage range in the main memory 51, and the target data is indicated as critical data using the critical notation when the address which corresponds to the tag field of the target address (i.e., the address of the target data) is within the critical data storage range in the main memory 51.

In step 508′, the control unit 97′ is configured to select a chosen way from the plurality of access ways according to whether the storage elements of the storage set which corresponds to the target address store valid data and whether the critical notation indicates that the target data corresponding to the target address in the main memory 51 is critical data.

Preferably, size of the data storage unit 96 of the cache memory apparatus 9′ is smaller than the critical data storage range in the main memory 51.

Preferably, the cache memory access method further comprises the following step.

In step 518′, the control unit 97 is configured to indicate the storage element written with the target data as storing critical data when the critical notation indicates that the target data corresponding to the target address in the main memory 51 is critical data.

In summary, the aforementioned preferred embodiments may not only overcome the issue encountered in the '386 patent, but may also overcome the issue encountered in the '358 patent by virtue of the critical data storage range in the main memory 51 being greater than the size of the data storage unit 96 of the cache memory apparatus 9′.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A cache memory access method to be implemented by a cache memory apparatus that is coupled electrically to a processor and a main memory, the cache memory apparatus including a data storage unit that includes a plurality of storage sets, each of the storage sets including a plurality of storage elements that correspond respectively to a plurality of access ways, the cache memory access method comprising:
configuring the cache memory apparatus to receive from the processer a target address;
configuring the cache memory apparatus to determine whether the data storage unit stores target data corresponding to the target address;
configuring the cache memory apparatus to receive the target data from the main memory after determining that the data storage unit does not store the target data corresponding to the target address;
configuring the cache memory apparatus to select a chosen way from the plurality of access ways according to whether the storage elements of the storage set which corresponds to the target address store valid data and whether the target address corresponds to a predefined lock range in the main memory; and
configuring the cache memory apparatus to write the target data in the data storage unit based on the chosen way.

2. The cache memory access method as claimed in claim 1, wherein the lock range in the main memory is larger than a size of the data storage unit of the cache memory apparatus.

3. The cache memory access method as claimed in claim 1, wherein the cache memory apparatus is configured to select the chosen way according to whether all of the storage elements that belong to the storage set corresponding to the target address and that correspond to a locked one of the access ways store critical data.

4. The cache memory access method as claimed in claim 3, wherein the step of selecting the chosen way includes a sub-step of:
configuring the cache memory apparatus to select a locked one of the access ways as the chosen way, the storage element that belongs to the storage set corresponding to the target address and that corresponds to the locked one of the access ways storing non-critical data.

5. The cache memory access method as claimed in claim 4, further comprising:
configuring the cache memory apparatus to indicate the storage element written with the target data as storing critical data when the target address corresponding to the storage set to which the storage element belongs is within the lock range.

6. The cache memory access method as claimed in claim 3, wherein the step of selecting the chosen way includes a sub-step of:
configuring the cache memory apparatus to select a locked one of the access ways as the chosen way, the storage element that belongs to the storage set corresponding to the target address and that corresponds to the locked one of the access ways storing non-valid data.

7. A cache memory apparatus to be coupled electrically to a main memory, the cache memory apparatus comprising:
a control unit defining a lock range in the main memory;
a data storage unit including a plurality of storage sets, each of which includes a plurality of storage elements; and
a critical bit unit for indicating whether data stored in each of the storage elements is within the lock range in the main memory;
wherein the lock range is larger than a size of the data storage unit.

8. The cache memory apparatus as claimed in claim 7, which is to be further coupled electrically to a processor, wherein the storage elements of each of the storage sets correspond respectively to a plurality of access ways, and the control unit is configured:
to receive from the processer a target address;
to determine whether the data storage unit stores target data corresponding to the target address;
to receive the target data from the main memory after determining that the data storage unit does not store the target data corresponding to the target address;
to select a chosen way from the plurality of access ways according to whether the storage elements of the storage set which corresponds to the target address store valid data and whether the target address corresponds to the lock range in the main memory; and
to write the target data in the data storage unit based on the chosen way.

9. The cache memory apparatus as claimed in claim 8, wherein the control unit is configured to select the chosen way according to whether all of the storage elements that belong to the storage set corresponding to the target address and that correspond to a locked one of the access ways store critical data.

10. The cache memory apparatus as claimed in claim 9, wherein the control unit is configured to select a locked one of the access ways as the chosen way, the storage element that belongs to the storage set corresponding to the target address and that corresponds to the locked one of the access ways storing non-critical data.

11. The cache memory apparatus as claimed in claim 10, wherein the control unit is configured to indicate the storage element written with the target data as storing critical data when the target address corresponding to the storage set to which the storage element belongs is within the lock range.

12. The cache memory apparatus as claimed in claim 9, wherein the control unit is configured to select a locked one of the access ways as the chosen way, the storage element that belongs to the storage set corresponding to the target address and that corresponds to the locked one of the access ways storing non-valid data.

13. A cache memory access method to be implemented by a cache memory apparatus that is coupled electrically to a processor and a main memory, the cache memory apparatus including a data storage unit that includes a plurality of storage sets, each of the storage sets including a plurality of storage elements that correspond respectively to a plurality of access ways, the cache memory access method comprising:
configuring the cache memory apparatus to receive from the processer a target address and a critical notation, the critical notation being for indicating whether a target data corresponding to the target address in the main memory is critical data;
configuring the cache memory apparatus to determine whether the data storage unit stores a target data corresponding to the target address;
configuring the cache memory apparatus to receive the target data from the main memory after determining that the data storage unit does not store the target data corresponding to the target address;
configuring the cache memory apparatus to select a chosen way from the plurality of access ways according to whether the storage elements of the storage set which corresponds to the target address store valid data and whether the critical notation indicates that the target data corresponding to the target address in the main memory is critical data; and
configuring the cache memory apparatus to write the target data in the data storage unit based on the chosen way.

14. The cache memory access method as claimed in claim 13,
wherein a size of the data storage unit of the cache memory apparatus is smaller than the critical data storage range in the main memory.

15. The cache memory access method as claimed in claim 13, wherein the cache memory apparatus is configured to select the chosen way according to whether all of the storage elements that belong to the storage set corresponding to the target address and that correspond to a locked one of the access ways store critical data.

16. The cache memory access method as claimed in claim 15, wherein the step of selecting the chosen way includes a sub-step of:
configuring the cache memory apparatus to select a locked one of the access ways as the chosen way, the storage element that belongs to the storage set corresponding to the target address and that corresponds to the locked one of the access ways storing non-critical data.

17. The cache memory access method as claimed in claim 16, further comprising:
configuring the cache memory apparatus to indicate the storage element written with the target data as storing critical data when the critical notation indicates that the target data corresponding to the target address in the main memory is critical data.

18. The cache memory access method as claimed in claim 15, wherein the step of selecting the chosen way includes a sub-step of:
configuring the cache memory apparatus to select a locked one of the access ways as the chosen way, the storage element that belongs to the storage set corresponding to the target address and that corresponds to the locked one of the access ways storing non-valid data.

19. A cache memory apparatus to be coupled electrically to a processor and a main memory, the cache memory apparatus comprising:
a control unit for receiving from the processor a target address and a critical notation, the critical notation being for indicating whether a target data corresponding to the target address in the main memory is critical data;
a data storage unit including a plurality of storage sets, each of which includes a plurality of storage elements; and
a critical bit unit for indicating whether data stored in each of the storage elements is critical data;
wherein the target data is indicated as critical data using the critical notation when the target address is within the critical data storage range in the main memory;
wherein a size of the data storage unit of the cache memory apparatus is smaller than the critical data storage range in the main memory.

20. The cache memory apparatus as claimed in claim 19, wherein the storage elements of each of the storage sets correspond respectively to a plurality of access ways, and the control unit is configured:
to receive from the processer the target address;
to determine whether the data storage unit stores the target data corresponding to the target address;
to receive the target data from the main memory after determining that the data storage unit does not store the target data corresponding to the target address;
to select a chosen way from the plurality of access ways according to whether the storage elements of the storage set which corresponds to the target address store valid data and whether the critical notation indicates that the target data corresponding to the target address in the main memory is critical data; and
to write the target data in the data storage unit based on the chosen way.

21. The cache memory apparatus as claimed in claim 20, wherein the control unit is configured to select the chosen way according to whether all of the storage elements that belong to the storage set corresponding to the target address and that correspond to a locked one of the access ways store critical data.

22. The cache memory apparatus as claimed in claim 21, wherein the control unit is configured to select a locked one of the access ways as the chosen way, the storage element that belongs to the storage set corresponding to the target address and that corresponds to the locked one of the access ways storing non-critical data.

23. The cache memory apparatus as claimed in claim 22, wherein the control unit is configured to indicate the storage element written with the target data as storing critical data when the critical notation indicates that the target data corresponding to the target address in the main memory is critical data.

24. The cache memory apparatus as claimed in claim 21, wherein the control unit is configured to select a locked one of the access ways as the chosen way, the storage element that belongs to the storage set corresponding to the target address and that corresponds to the locked one of the access ways storing non-valid data.
